(19) United States
(12) Patent Application Publication
(10) Pub. No.: US 2003/0214584 A1
(43) Pub. Date: Nov. 20, 2003

(54) Side and rear vision enhancement for vehicles

(76) Inventor: Bruce Eliot Ross JR., Charlotte, NC (US)

Correspondence Address: Bruce Eliot Ross JR., 13319 WOODLAND FARM DR., CHARLOTTE, NC, 28215, US

(21) Appl. No.: 10/145,537

(22) Filed: May 14, 2002

(51) Int. Cl. H04N 7/18

(52) U.S. Cl. 348/148; 348/159

(57) ABSTRACT

A system that enables enhanced vision while driving a vehicle generally three respects: (1) extended vision in front and perpendicular to the vehicle, (2) rearward vision without the “blind” spots caused by mirrors and (3) rear detection of faster oncoming traffic. A pair of side view cameras integrated into the headlight assembly of a vehicle allows extended vision perpendicular to the direction of vehicular travel, such that an obstruction beside the vehicle will not block vision. A pair of rear view cameras also preferably integrated into the headlight assembly of the vehicle allows rearward vision to be displayed where a rear view mirror is typically positioned. A speed and distance-detecting device, such as a laser or radar gun, is mounted near the rear bumper in order to observe the speed of an approaching vehicle.

### BACKGROUND OF THE INVENTION

1. Field of the Invention

The present invention relates to vision enhancing devices for vehicles. Specifically detailing devices for improving side and rear vision.

2. Background of the Invention

Impaired vision causes thousands of vehicle accidents every year. The vision of the driver can be blocked by an obstruction beside the vehicle, such as an adjacent vehicle, parked cars, overgrown vegetation or other objects. For example, if the driver desired to turn right out of an alley, but could not clearly see oncoming traffic due to a parked vehicle. Another example would be if a driver were to come to a four-lane street, a vehicle immediately in front and slightly to the left of the driver could obstruct the drivers view, causing the driver to slowly enter the intersection to see past the adjacent vehicle. Oftentimes vegetation planted too close to a road also impedes the vision of the driver, thereby causing a similar problem. “Blind” spots caused by rear view mirrors are another problem experienced by drivers of vehicles. Side view mirrors are incapable of showing a particular area adjacent to the driver. Although the driver is supposed to actually look before switching lanes, reliance on the rear view mirrors causes many accidents where another vehicle is in a “blind” spot. Another “blind” spot that causes many accidents is a quickly approaching vehicle that is adjacent to the driver before detection. If the driver switches lanes without detecting the approaching vehicle, the driver may pull out in front of the approaching vehicle, side swipe the vehicle or hit the vehicle in front of them as a reflex to missing the approaching vehicle. Therefore, there is a need for a system that reduces the vision impairment of prior art vehicles.

### SUMMARY OF THE INVENTION

According to its major aspects and broadly stated, the present invention is a system that enhances vision for the driver of a vehicle in order to minimize “blind” spots. The system provides vision enhancements in generally three respects: (1) extended vision in front and perpendicular to the vehicle, (2) rearward vision without the “blind” spots caused by mirrors and (3) rear detection of oncoming traffic. A pair of side view cameras mounted on each side of the vehicle and positioned near the front bumper, preferably integrated into the headlight assembly, allows extended vision perpendicular to the vehicle, such that an obstruction beside the vehicle will not block vision. A pair of rear view cameras also preferably integrated into the vehicle's headlight assembly allows rearward vision that is displayed where a side view mirror is typically positioned. A speed-detecting device, such as a laser gun, is mounted near the rear bumper in order to observe the speed and distance of oncoming traffic.

A major advantage of the present invention is the ability to perceive areas in front of and to the side of the vehicle. A side view camera integrated into the headlight assembly on each side of the vehicle allows the driver to have an extended viewing area. As a result, the driver need not enter an intersection to see around an obstruction.

The ability to have a rearward display without “blind” spots is an important advantage of the present invention. In prior art vehicles with side view mirrors, an area beside the vehicle could not be seen by the mirror and is the cause of numerous accidents. In contrast, the present system supplies rear view cameras and corresponding rear view monitors that allow the driver to see the entire area beside the vehicle. Consequently, the driver is less likely to get into an accident caused by impaired vision.

Another important advantage of the present invention is the ability of safer passing by detecting the speed and distance of oncoming vehicles. Many times, a driver that is passing on an interstate does not have complete or accurate information on the speed of oncoming traffic. As a result, the driver may pull out in front of a vehicle traveling at a much greater rate of speed than expected.

Other features and their advantages will be apparent to those skilled in the art from a careful reading of the Detailed Description of Preferred Embodiments accompanied by the following drawings.

### BRIEF DESCRIPTION OF THE DRAWINGS

In the drawings,

FIG. 1 is a top view of a vehicle carrying a vision enhancing system in traffic, according to a preferred embodiment of the present invention;

FIG. 2 is a front perspective view of a vehicle carrying a vision enhancing system, according to a preferred embodiment of a present invention;

FIG. 3 is a rear perspective view of a vehicle carrying a vision enhancing system, according to a preferred embodiment of the present invention; and

FIG. 4 is a detailed view of a vehicle console carrying a vision enhancing system, according to a preferred embodiment of the present invention.

### DETAILED DESCRIPTION OF PREFERRED EMBODIMENTS

The present invention is a system that allows enhanced vision while driving a vehicle in order to reduce all possible “blind” spots. Referring now to the figures, there is shown a system according to a preferred embodiment of the present invention, indicated generally by reference number 10. In terms of orientation, system 10 is mounted on a vehicle 1 having a left side 12, right side 14, front 16, and rear 18. System 10 comprises a pair of side view cameras 30 integrated into each side 12 and 14 of the vehicle 1 in headlight assembly 3 to allow extended vision perpendicular to vehicle 1, a pair of rear view cameras 40 also integrated into the vehicle 1 headlight assembly 3 on each side 12 and 14 of vehicle 1 to allow rearward vision, and a speed detecting device 50 mounted near the rear window of the vehicle 1 allow sensing of the speed and distance of an approaching vehicle( not shown). Both side view cameras 30 and rear view cameras 40 are video cameras that allow the driver to view real-time images.

Rear View Cameras

A pair of rear view cameras 40 allows a driver to see beside and behind vehicle 1, without the “blind” spots that occur when mirrors are used. A rear view camera 40 is preferably integrated into the headlight assembly 3 of vehicle 1 on both the left side 12 and the right side 14 of vehicle 1 to allow rearward vision. Rear view cameras 40 preferably have a wide angle viewing to see all rearward approaching traffic from both left side 12 and right side 14. Each rear view camera 40 has an open position that allows rearward vision and a close-in position in which rear view camera 40 is flush with vehicle 1. Rear view cameras 40 are in the open position unless vehicle 1 is turned off or if either rear view camera 40 is sufficiently close to another object, preferably not more than 10 inches.

Each rear view camera 40 is in communication with a sensor 44 that detects the distance that objects are from a corresponding rear view camera 40. Each sensor 44 controls the position of a rear view camera 40, to the extent that sensors 44 will place a corresponding rear view camera 40 in a closed position if an object gets too close to a corresponding rear view camera 40.

A pair of monitors 42 in communication with a rear view cameras 40 allows a driver to see images seen by rear view cameras 40. Monitors 42 are preferably positioned in the place where side view mirrors typically are positioned as illustrated in FIG. 3. Monitor 42 positioned on left side preferably displays information from rear view camera 40 on left side 12, while monitor 42 positioned on right side preferably displays information from rear view camera 40 on right side 14 of vehicle.

Side View Cameras

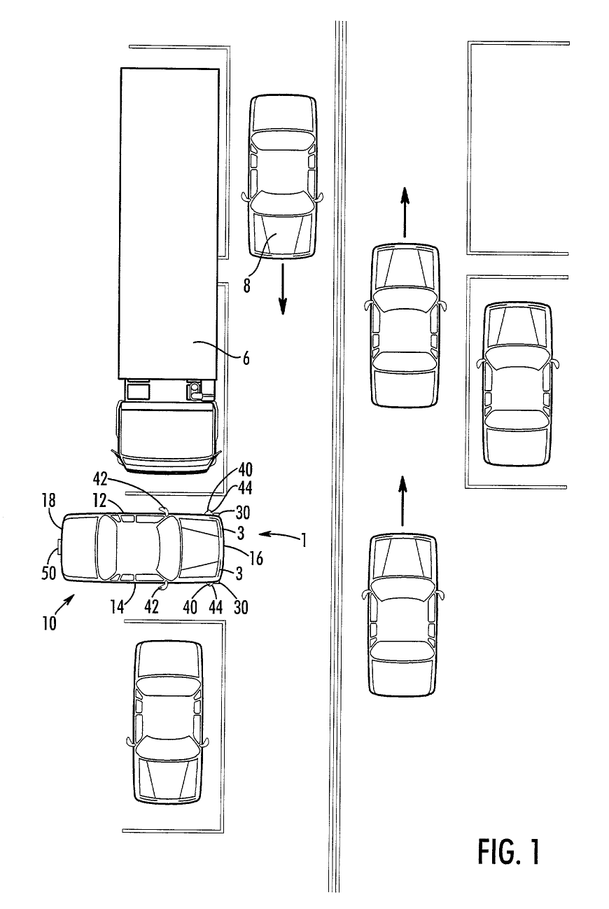

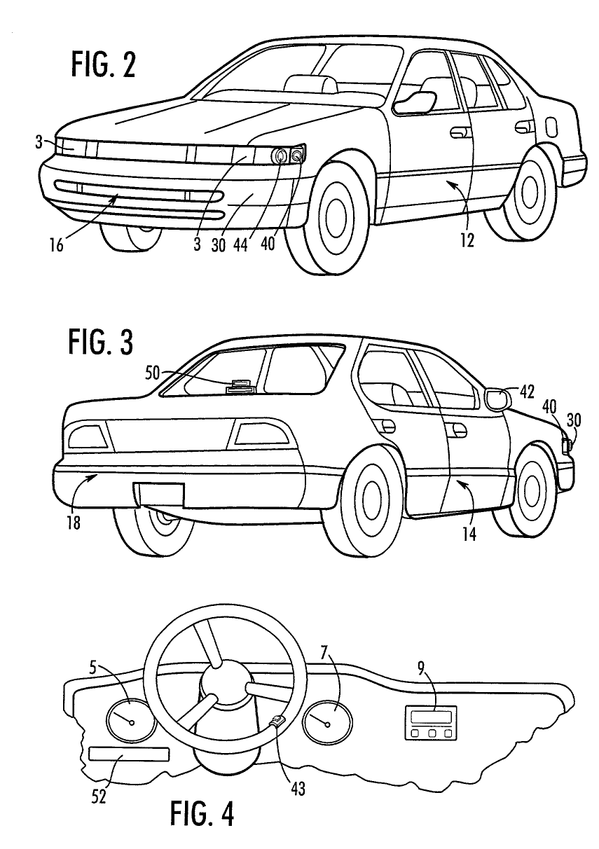

Side view cameras 30 enable a driver to see oncoming traffic 8 coming from a direction perpendicular to the direction of travel of vehicle 1, a direction that might otherwise be blocked from view by an obstruction 6, such as another vehicle, vegetation, or other objects as illustrated in FIG. 1. Side view cameras 30 are mounted on both left side 12 and right side 14 of vehicle 1 and preferably integrated into headlight assembly 3. In order to prevent water penetration into either side view camera 30, a water-proof camera or sufficient shielding should be used. Preferably, side view cameras 30 are controlled by a motor (not shown) that allows horizontal movement. The motor, in turn, may be controlled by the driver using an input device (not shown). A monitor 42 in communication with side view cameras 30 allows a driver to see images of side view cameras 30. Although monitor 42 displays rear view cameras images by default, the driver may change the view by touching a second input device 43. Upon engaging a second input device 43, side view camera images will be displayed for a short period of time and then change back to displaying the rear view cameras. Second input device 43 is preferably positioned to allow easy access for the driver, such as integration with the steering wheel. Monitor 42 positioned on left side preferably displays information from side view camera 30 on left side 12, while monitor 42 positioned on right side preferably displays information from side view camera 30 on right side 14 of vehicle.

Rear Speed and Distance Detection

A speed detection device 50 near the rear window of vehicle 1 allows the driver to determine how fast approaching traffic is moving and optionally the distance of approaching traffic. This is especially useful when the driver is traveling on an interstate and would like to change lanes or is in a lane where oncoming traffic is approaching a faster pace than the driver. Speed and distance detection device 50 could be a laser or radar gun, commonly used in police vehicles to determine how fast a vehicle is traveling or any other device in the art that is capable of determining the speed and distance of moving objects. A speed and distance monitor 52 in communication with speed detection device 50 displays the speed and distance detected by speed and distance device 50. Preferably, speed and distance monitor 52 is positioned next to the vehicle speedometer 5, as illustrated in FIG. 1.

In use, a driver may “see around” perpendicular obstructions, meaning obstructions that are perpendicular to the direction of travel, using side view cameras 30. In order to view rearview traffic, viewing monitors can use rear cameras. The driver can detect the speed and distance of rearward oncoming traffic using speed detection device 50 by viewing speed detection monitor 52.

It will be apparent to those skilled in the art that many changes and substitutions can be made to the preferred embodiment herein described without departing from the spirit and scope of the present invention, which is defined by the appended claims.

What is claimed is:

1. An enhanced vision system for a vehicle having a front bumper and a rear bumper, said vision system comprising:
A side view camera secured to the front bumper of the vehicle, said side view camera positioned perpendicular to the vehicle;
A side view monitor in communication with said side view camera;
A rear view camera secured to the front bumper of the vehicle, said rear view camera positioned approximately parallel to the vehicle;
A rear view camera in communication with said rear view camera;
and means for detecting the speed and distance of oncoming vehicle, said detecting means mounted to the rear bumper of a vehicle.
